(19) United States
(12) Patent Application Publication
(10) Pub. No.: US 2014/0025980 A1
(43) Pub. Date: Jan. 23, 2014

(54) POWER SUPPLY SYSTEM

(71) Applicant: HON HAI PRECISION INDUSTRY CO., LTD., New Taipei (TW)

(72) Inventors: HSIEN-CHUAN LIANG, New Taipei (TW); SHOU-KUO HSU, New Taipei (TW)

(21) Appl. No.: 13/940,302

(22) Filed: Jul. 12, 2013

(30) Foreign Application Priority Data
Jul. 18, 2012 (TW) 101125856

(51) Int. Cl. G06F 1/32

(52) U.S. Cl. CPC G06F 1/3287
USPC 713/324

(57) ABSTRACT

A power supply system supplies power includes a single power supply unit to supply power for a number of motherboards. A number of power management chips are provided corresponding to the motherboards, to monitor a real-time power consumption of each motherboard. A microcontroller is connected to each of the motherboards through a data line, to control a total power consumption of the motherboards to control power consumption to remain within a nominal power of the power supply unit.

### BACKGROUND

1. Technical Field

Embodiments of the present disclosure relate to power supply technologies, and particularly to, a power supply system for a plurality of motherboards.

2. Description of Related Art

Power supply circuits for servers may include a power output circuit for outputting a plurality of different voltages (e.g., 12V, 5V and 3.3V). Servers may include a power supply unit (PSU) to supply power for a motherboard of the server. However, when the server includes a plurality of motherboards (e.g., three or four), one PSU is not enough for all of the motherboards. Thus, more PSUs may be needed, which increases the costs of the server. Therefore, there is room for improvement in the art.

### BRIEF DESCRIPTION OF THE DRAWINGS

FIG. 1 illustrates a schematic diagram of one embodiment of a power supply system for a plurality of motherboards.

FIG. 2 illustrates an example of a power supply unit (PSU) of FIG. 1 providing a plurality of voltages for a motherboard (MB).

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

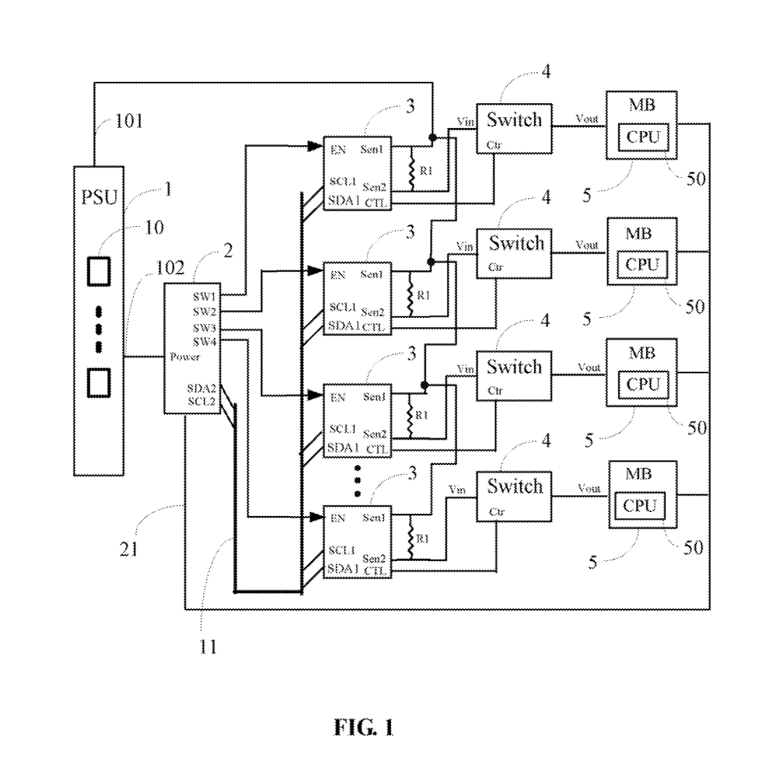

Referring to FIG. 1, a power supply system that supplies power for a plurality of motherboards (MBs) 5 of a computing device (e.g., server) is shown. The power supply system includes a power supply unit (PSU) 1, a microcontroller 2, a plurality of power management chips 3, and a plurality of switches 4.

The PSU 1 includes a voltage output port 101 and a power control port 102.

In the embodiment, the PSU 1 may consist of one or more power devices 10 having a predetermined nominal power. A nominal power of the PSU 1 is equal to a sum of the nominal powers of the one or more power devices 10.

Each switch 4 includes a voltage input terminal (Vin), a voltage output terminal (Vout), and a control terminal (Ctr) that controls the corresponding switch 4 to switch on or off. The voltage input terminal (Vin) of each switch 4 is electrically connected to the voltage output port 101 via a first resistor R1. The voltage output terminal (Vout) is electrically connected to a corresponding motherboard 5 to supply power to the motherboard 5. The voltages output from the PSU 1 are transmitted to each of the motherboards 5 through a corresponding one of the switches 4. In the embodiment, a number of power devices included in the PSU 1 is less than a number of the motherboards 5. Particularly, the PSU 1 includes two power devices, and the number of the motherboards 5 is four.

Each power management chip 3 includes an enable pin EN, a control pin CTL, a first sensing pin Sen1, a second sensing pin Sen2, a first serial data pin SDA1, and a first serial clock pin SCL1. The control pin CTL of each power management chip 3 is connected to the control terminal Ctr of a corresponding switch 4, to control the corresponding switch 4 to switch on or off. The first sensing pin Sen1 and the second sensing pin Sen2 are connected to two opposite ends of the first resistor R1, respectively. Each power management chip 3 detects a real-time power consumption of a corresponding motherboard 5 using the first sensing pin Sen1 and the second sensing pin Sen2, and sends the detected real-time power consumption of the corresponding motherboard 5 to the microcontroller 2. In the embodiment, each power management chip 3 detects voltages at the two opposite ends of the first resistor R1 in real-time using the first sensing pin Sen1 and the second sensing pin Sen2, and then calculates the real-time power consumption of the corresponding motherboard 5 according to the detected voltages.

The microcontroller 2 includes a plurality of switch terminals (e.g., SW1, SW2, SW3, and SW4), a second serial data pin SDA2, a second serial clock pin SCL2, and a power feedback terminal Power connected to the power control terminal 102 of the PSU 1. Each of the switch terminals is connected to the enable pin EN of a corresponding power management chip 3, to enable or disable the corresponding power management chip 3. The second serial data pin SDA2 is connected to the first serial data pin SDA1 of each of the power management chips 3 through a serial data line of a power management bus (PM bus) 11 to establish data transmission between the microcontroller 2 and each of the power management chips 3. The second serial clock pin SCL2 is connected the first serial clock pin SCL1 of each of the power management chips 3 through a serial clock line of the power management bus 11 to send clock signals to each of the power management chips 3. In the embodiment, the power management bus 11 is an inter integrated circuit (I²C) bus.

The microcontroller 2 receives the real-time power consumption of each of the motherboards 5 feedback from the power management chips 3 through the serial data line of the power management bus 11, and calculates a total power consumption of the motherboards 5. In the embodiment, the microcontroller 2 is further connected to each of the motherboards 5 through a data line 21. The microcontroller 2 controls the total power consumption of the motherboards 5 to remain within the nominal power of the PSU 1. For example, when the total power consumption of one or more started motherboards 5 reaches or nears the nominal power of the PSU 1, the microcontroller 2 may limit or delay startup of one or more of the motherboards 5 which have not been started. In other embodiments, when the total power consumption of the motherboards 5 reaches or nears the nominal power of the PSU 1, the microcontroller 2 may send a control signal to the PSU 1 through the power feedback terminal (Power) to directly turn off the PSU 1, thereby protecting the PSU 1. In the embodiment, when total power consumption of the motherboards 5 exceeds a predetermined value, it is determined that the total power consumption of the motherboards 5 reaches or nears the nominal power of the PSU 1.

In other embodiments, when the total power consumption exceeds a predetermined value, the microcontroller 2 controls one or more started motherboards 5 to reduce the working loads of the one or more started motherboards 5 according to a predetermined priority level of each of the motherboards 5. In one example, the microcontroller 2 may send an alarm signal to a central processing unit (CPU) 50 of a started motherboard 5 which has a lower priority level, to control the CPU 50 to reduce its working frequency, thereby controlling the total power consumption of the motherboards 5 to remain within the nominal power of the PSU by decreasing the power consumption of the motherboard 5 having the lower priority level. The predetermined priority level of each of the motherboards 5 may be predetermined by a user and stored in the microcontroller 2.

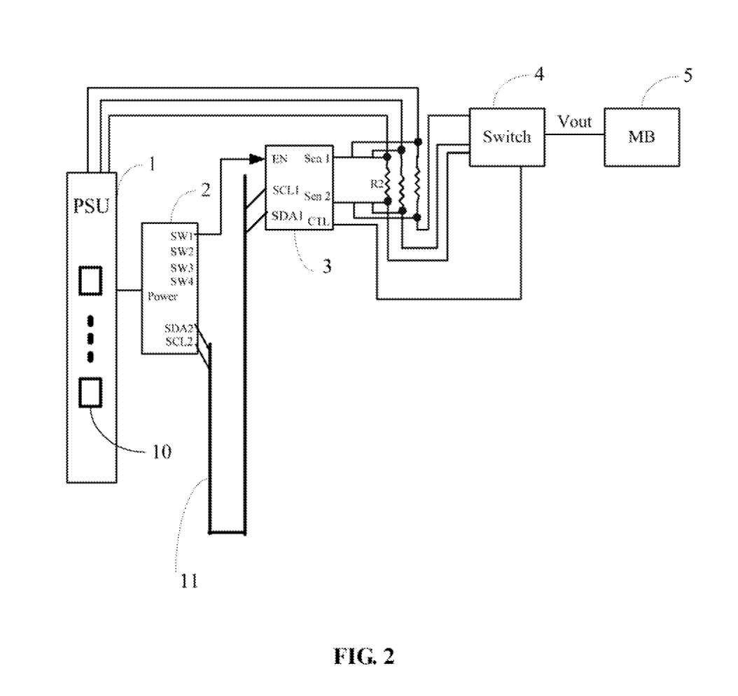

In another embodiment, referring to FIG. 2, the PSU 1 may provide a plurality of voltages with different values, such as 12V, 5V, and 3.3V. Each switch 4 selectively transmits one of the voltages to a corresponding motherboard 5 under the control of the corresponding power management chip 3. Each switch 4 may include a plurality of switch components (not shown) electrically connected to the plurality of voltages through a respective second resistor R2. The corresponding power management chip 3 selectively controls one of the switch components off, thereby transmitting one of the plurality of voltages to the corresponding motherboard 5 according to requirements. Accordingly, two opposite ends of each second resistor R2 are electrically connected to the first sensing pin Sen1 and the second sensing pin Sen2 of the corresponding power management chip 3. Thus, no matter which of the voltages is transmitted to the motherboard 5, the corresponding power management chip 3 can monitor the power consumption of the motherboard 5.

As described above, the present power supply system uses a single power supply unit to supply power for a plurality of motherboards, and monitors a total power consumption of the motherboards in real-time. When the total power consumption reaches or nears the nominal power of the power supply unit, the working loads of the motherboards are adjusted to remain the total power consumption of the motherboards within the nominal power of the power supply unit. Since a single power supply unit can supply power for a plurality of motherboards, the cost of the computing device having a plurality of motherboards is decreased.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A power supply system for a plurality of motherboards of a computing device, comprising:
a power supply unit, a microcontroller, a plurality of power management chips, and a plurality of switches, wherein:
each of the switches comprises a voltage input terminal and a voltage output terminal, the voltage input terminal of each of the switches is electrically connected to the power supply unit, and the voltage output terminal of each of the switches is electrically connected to a corresponding motherboard to supply power to the corresponding motherboard;
each of the power management chips is electrically connected to the microcontroller via a power management bus, to detect a real-time power consumption of a corresponding motherboard and transmits the real-time power consumption of the corresponding motherboard to the microcontroller;
the microcontroller is electrically connected to each of the motherboards through a data line, to control a total power consumption of the motherboards to remain within a nominal power of the power supply unit.

2. The power supply system according to claim 1, wherein the power supply unit consists of one or more power devices having a predetermined nominal power, and the nominal power of the power supply unit is equal to a sum of the nominal powers of the one or more power devices.

3. The power supply unit according to claim 2, wherein a number of the power devices of the power supply unit is less than a number of the motherboard.

4. The power supply unit according to claim 3, wherein the power supply unit comprises two power devices and the number of the motherboards is four.

5. The power supply system according to claim 1, wherein each of the power management chips comprises a first serial data pin and a first serial clock pin, the microcontroller comprises a second serial data pin and a second serial clock pin, the second serial data pin is connected to the first serial data pin of each of the power management chips through a serial data line of the power management bus to establish data transmission between the microcontroller and each of the power management chips, the second serial clock pin is connected the first serial clock pin of each of the power management chips through a serial clock line of the power management bus to send clock signals to each of the power management chips.

6. The power supply system according to claim 1, wherein the power management bus is an inter integrated circuit (I²C) bus.

7. The power supply system according to claim 1, wherein each of the switches comprises a control terminal, each of the power management chips comprises a control pin; the control pin of each of the power management chips is connected to the control terminal a corresponding switch to control the corresponding switch to on or off.

8. The power supply system according to claim 1, wherein when the total power consumption of one or more started motherboards exceeds a predetermined value, the microcontroller limits or delays startup of one or more of the motherboards which have not been started.

9. The power supply system according to claim 1, wherein when the total power consumption of the motherboards exceeds a predetermined value, the microcontroller controls one or more started motherboards to reduce working loads of the one or more started motherboards according to a predetermined priority level of each of the motherboards.

10. The power supply system according to claim 9, wherein when the total power consumption exceeds a predetermined value, the microcontroller sends an alarm signal to a central processing unit of a started motherboard which has a lower priority level, to control the central processing unit to reduce a working frequency of the central processing unit.

11. The power supply system according to claim 1, wherein each of the power management chips comprises a first sensing pin and a second sensing pin, the first sensing pin and the second sensing pin are connected to two opposite ends of the resistor, respectively, each of the power management chips detects voltages at the two opposite ends of the resistor in real-time using the first sensing pin and the second sensing pin, and then calculates the real-time power consumption of the corresponding motherboard according to the detected voltages.

12. The power supply system according to claim 1, wherein the power supply unit provides a plurality of voltages with different value, each of the switches selectively transmits one of the voltages to a corresponding motherboard under control of a corresponding power management chip.
